(19) United States
(12) Patent Application Publication
(10) Pub. No.: US 2008/0195503 A1
(43) Pub. Date: Aug. 14, 2008

(54) Methods for increasing the amount of time that customers spend reviewing and shopping for products within an on-line environment

(76) Inventor: Gabriel R. Habeishi, Rutherford, NJ (US)

Correspondence Address: Gabriel Habeishi;Suite 2000, 149 Mountain Way, Rutherford, NJ, 07070-2453, US

(21) Appl. No.: 11/706,672

(22) Filed: Feb. 13, 2007

(51) Int. Cl. G06Q 30/00; G06Q 90/00

(52) U.S. Cl. 705/26

(57) ABSTRACT

The present invention relates to methods and systems for offering products on-line and, furthermore, to methods of increasing the amount of time that customers spend reviewing and shopping for products within an on-line environment. According to certain preferred embodiments of the present invention, methods are provided for offering products for sale in an on-line environment, such as within a website. The methods generally comprise (a) providing a customer with a user platform within a terminal, e.g., providing a customer with a website accessible through a networked computer, (b) receiving an instruction from the customer to launch a game module and transmitting the instruction to a server, (c) launching the game module from the server, wherein the game module is operated by the customer using the terminal and unexceptionally results in and provides the customer with an awarded discount, and (d) offering the customer an option to purchase a product for a price that is reduced by the awarded discount. Preferably, the customer is provided the opportunity to select a product to purchase from a plurality of options. The invention provides that the customer is able to launch the game module without paying any fees, such that the customer will be motivated to play a game, thereby increasing the amount of time that such customer spends within the on-line environment.

### FIELD OF THE INVENTION

The present invention relates to the field of e-commerce. More particularly, the present invention relates to methods and systems for offering products on-line and, furthermore, to methods of increasing the amount of time that customers spend reviewing and shopping for products within an on-line environment.

### BACKGROUND OF THE INVENTION

The field of e-commerce has become fiercely competitive over the past several years as numerous business, both new and old, have started offering goods for sale within websites and other on-line environments. Indeed, in 2006, several billions of dollars in products were estimated to have been sold over the internet. As a result, there is an ongoing and rapidly growing need for on-line businesses to implement procedures that attract customers to their websites and, moreover, increase the amount of time that such customers spend within such websites. Of course, by increasing the amount of time that a customer spends within a website, the probability of such customer making a purchase is increased.

There have been numerous attempts to develop on-line games and other methods to increase the amount of time that consumers spend reviewing and shopping for products within on-line environments. Examples of such methods are found in U.S. Pat. Nos. 6,443,843 and 5,620,182, as well as U.S. Patent Application Publication 2002/0143619, which patents and patent application are hereby incorporated by reference, in their entirety. In some cases, websites have employed games that allow a customer to win money towards the purchase of a product, or win a discount on a product, if such customer is successful and “wins,” but does not “lose,” the game. Many of these games, however, will require that the customer pay a fee, or at least make a deposit, using a credit or debit card before the game may be played. In many cases, this fee or deposit may be sacrificed if the customer “loses” the game. In other instances, the games may obligate the customer to make a purchase of a product in exchange for playing a game that offers the chance of winning a discount.

Many of the foregoing methods, however, are not desirable insofar as such methods require consumers to deposit an initial fee. Other methods require and obligate consumers to actually purchase a good in exchange for playing a game. Still further, other methods are even designed such that a customer may actually lose money by playing a game, which may implicate and/or violate onerous and complicated gambling laws. These methods are not effective in increasing the amount of time that consumers review and shop within a website, insofar as customers do not want to make an initial deposit of any sort to play a game, which requires the customer to enter credit or debit card information. Of course, neither do such customers wish to actually lose money, or be obligated to purchase a good, in order to play a game.

In light of the foregoing, there is a continuing need for new methods of increasing the amount of time that customers review and shop for products within websites, which do not involve any initial deposits of money, obligations to purchase a product, or the risk of actually losing money. As explained further below, the present invention provides many of the foregoing needs.

### SUMMARY OF THE INVENTION

According to certain preferred embodiments of the present invention, methods are provided for offering products for sale in an on-line environment, such as within a website. The methods generally comprise (a) providing a customer with a user platform within a terminal, e.g., providing a customer with a website accessible through a networked computer, (b) receiving an instruction from the customer to launch a game module and transmitting the instruction to a server, (c) launching the game module from the server, wherein the game module is operated by the customer using the terminal and unexceptionally results in and provides the customer with an awarded discount, and (d) offering the customer an option to purchase a product for a price that is reduced by the awarded discount. Preferably, the customer is provided the opportunity to select a product to purchase from a plurality of options. The invention provides that the customer is able to launch the game module without paying any fees, such that the customer will be motivated to play the game and more likely to make a purchase.

The implementation of the game module may be carried out in different forms. Any games of chance, games of skill, or combinations thereof may be employed in a graphical user interface, which provides an entertaining gaming experience. In certain preferred embodiments of the invention, the game is manifested in a graphical user interface in the form of a conventional gambling-type game, such as rolling dice. The invention further provides that the customer may be allowed to launch the game module multiple times, such that each time the game module is launched the customer has a chance of being awarded a different discount.

According to the methods of the present invention, each product is offered for sale by a merchant. Each merchant is provided with the opportunity to specify an initial selling price for each product that it will offer for sale within the website in which the methods of the invention are carried out. In addition, the merchant may be provided with the ability to specify a maximum discount at which each product may be sold. The initial selling price and maximum discount are provided to a server that hosts, or is capable of communicating with a server that hosts, the game module. Each merchant will preferably be able to specify the initial selling price, and maximum discount, for each product within a terminal, such as a computer through which a website may be accessed, which is capable of communicating with the server (e.g., vis-à-vis the internet).

The invention provides that the awarded discount that each customer is provided by playing a game, and is able to apply towards the purchase of a product, will be less than or equal to the maximum discount that a merchant assigns to such product. This limitation may be implemented in various ways. For example, when the awarded discount is produced by the game module, the server may query a database of products that a plurality of merchants have offered for sale. The server may then cause to be displayed to the customer within the website only those products having a maximum discount value that is equal to or greater than the awarded discount. In such embodiments of the invention, products that are displayed and offered for sale to the customer will not include products having a maximum discount that is assigned by the merchant that is less than the awarded discount. The invention provides that the awarded discount may be implemented in various ways, such as in the form of a dollar amount by which the initial selling price of a product will be reduced or percentage reduction of the initial selling price.

According to additional preferred embodiments of the present invention, methods are provided for increasing the amount of time that a customer spends reviewing and shopping within an on-line environment. Similar to the other methods described above, such embodiments of the present invention generally comprise (a) providing a customer with a user platform within a terminal, e.g., providing a customer with a website accessible through a networked computer, (b) receiving an instruction from the customer to launch a game module and transmitting the instruction to a server, (c) launching the game module from the server, wherein the game module is operated by the customer using the terminal and unexceptionally results in and provides the customer with an awarded discount, and (d) offering the customer an option to purchase a product for a price that is reduced by the awarded discount. Preferably, the customer is provided the opportunity to select a product to purchase from a plurality of options. According to such embodiments of the invention, the customer is able to launch the game module without paying any fees or making any deposits, such that the customer will be motivated to play a game and, as a result, spend more time within the website and shopping for products therein.

The above-mentioned and additional features of the present invention are further illustrated in the Detailed Description contained herein.

### BRIEF DESCRIPTION OF THE FIGURES

FIG. 1 is an example of a graphical user interface showing an on-line environment in which the methods of the invention may be carried out, which includes a showcase of products and the ability to execute a game module.

FIG. 2 is the bottom portion of the graphical user interface of FIG. 1, which showcases additional products.

FIG. 3 is an example of a graphical user interface showing the execution of a game module, which provided the customer with an awarded discount of 6% off the initial selling price of the products shown therein.

FIG. 4 is an example of a graphical user interface showing the execution of a game module, which provided the customer with an awarded discount of 10% off the initial selling price of the products shown therein.

FIG. 5 is an example of a graphical user interface showing the election of a customer to purchase a product, wherein the initial selling price of such product is reduced by the awarded discount shown in FIG. 4.

FIG. 6 is an example of a graphical user interface that provides a customer login portal.

FIG. 7 is an example of a graphical user interface that provides a registration form into which prospective customers may enter information in order to apply for rights to purchase products within the on-line environment of the present invention.

FIG. 8 is an example of a graphical user interface that provides a merchant login portal.

FIG. 9 is an example of a graphical user interface that allows a merchant to specify the initial selling price and maximum awarded discount for a product to be offered for sale within the showcase described herein.

FIG. 10 is an example of a graphical user interface showing an on-line environment in which the methods of the invention may be carried out, which includes a showcase of products and the ability to execute and be awarded a flat-rate discount on the products shown therein.

FIG. 11 is an example of a graphical user interface that provides a content search portal, which enables a customer to search the contents of the product showcase.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

According to certain preferred embodiments of the present invention, methods are provided for offering products for sale in an on-line environment, such as within a website. The methods generally comprise (a) providing a customer with a user platform within a terminal, e.g., providing a customer with a website accessible through a networked computer, (b) receiving an instruction from the customer to launch a game module and transmitting the instruction to a server, (c) launching the game module from the server, wherein the game module is operated by the customer using the terminal and unexceptionally results in and provides the customer with an awarded discount, and (d) offering the customer an option to purchase a product for a price that is reduced by the awarded discount.

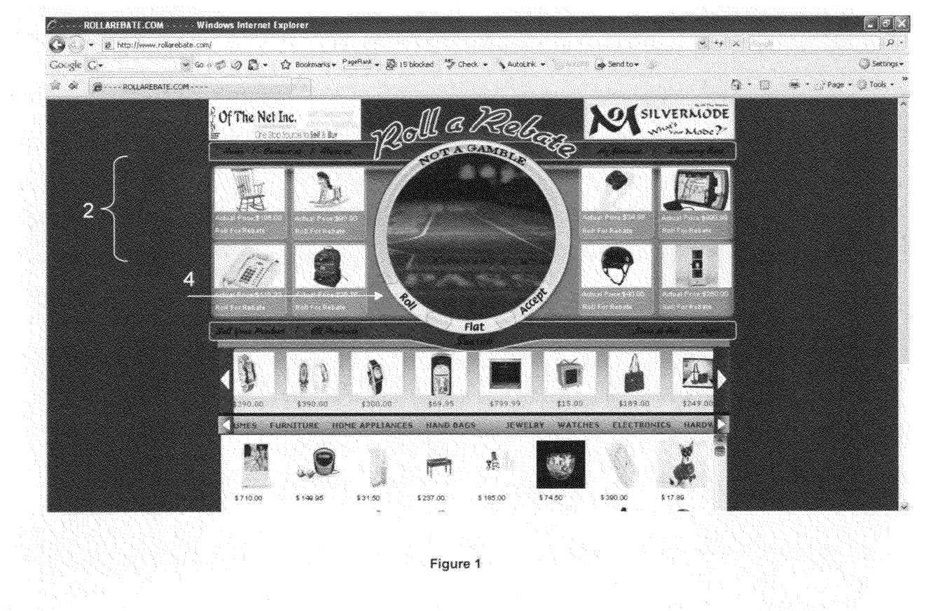

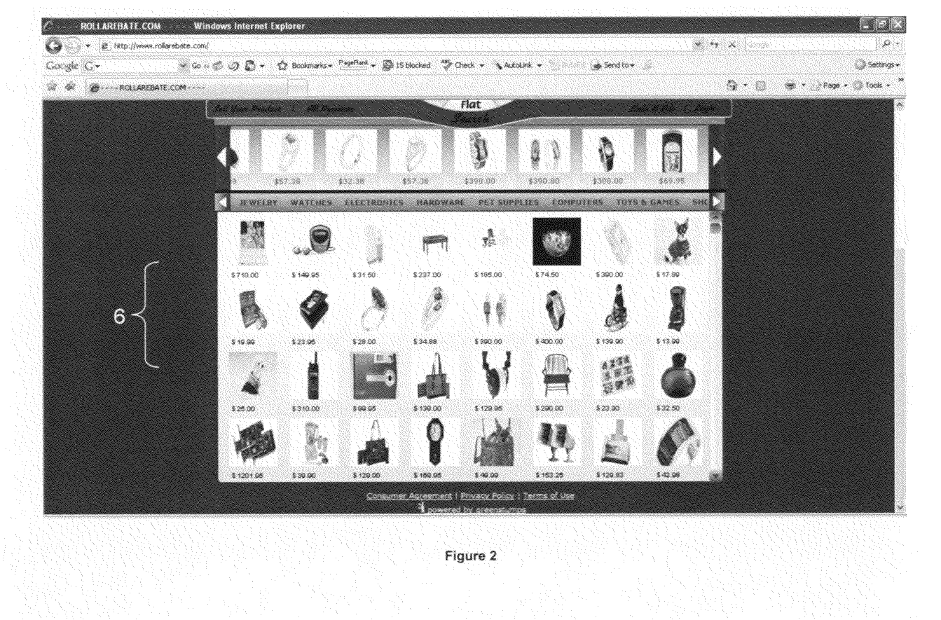

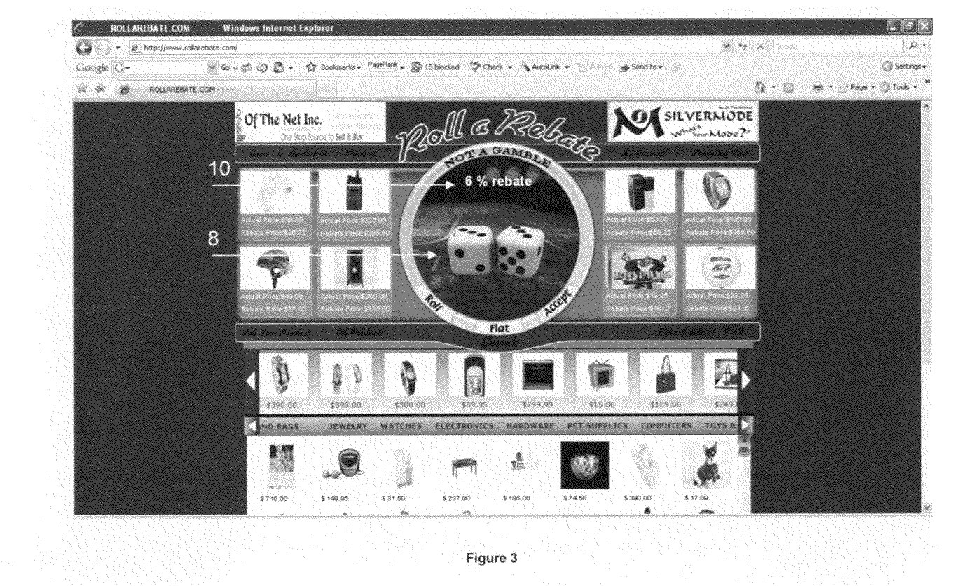

Referring to FIGS. 1 and 2, for example, the user platform may be implemented in the form of a website that is hosted and managed from a server. The website exhibits a plurality of products that are offered for sale, which is also referred to herein as the “showcase” 2,6. The user platform includes a customer-executable means for launching a game module. In FIG. 1, for example, a game module is executed when a customer selects, or “clicks,” on the icon labeled “Roll” 4. When a customer executes the game module, an instruction is provided to the server that hosts the website, wherein the instruction launches the game module. For example, referring to FIG. 3, upon executing the game module 4 shown therein, a graphical user interface is produced showing a pair dice 8 being rolled. The rolling dice are shown alongside an awarded discount 10, which in the example shown in FIG. 3 is 6%.

The invention provides that the customer is able to launch the game module 4 without (a) paying any fees, (b) being required to make any type of initial deposit using a credit or debit card, or (c) being obligated to purchase a produce. The risk-free, costless, and burden-free nature of the game module significantly increases the chance that a customer will play a game. The byproduct of launching a game module, namely, awarding the customer a discount) on the optional purchase of a product, has been shown to significantly increase the amount of time that customers spend visiting an e-commerce website that employs such methods of the present invention.

In addition, the invention provides that the game module 4 is preferably launched by the customer using only a single command. For example, the game module 4 may be launched by the customer by a single “click” on an icon 4 that, when selected, instructs the server to launch the game module. The “one click” nature of the customer-executable command lessens the burden for a customer to play the game, thereby increasing the chance that the game will be played. Of course, this translates into more time spent within the website and, moreover, an increased chance of the customer making a purchase.

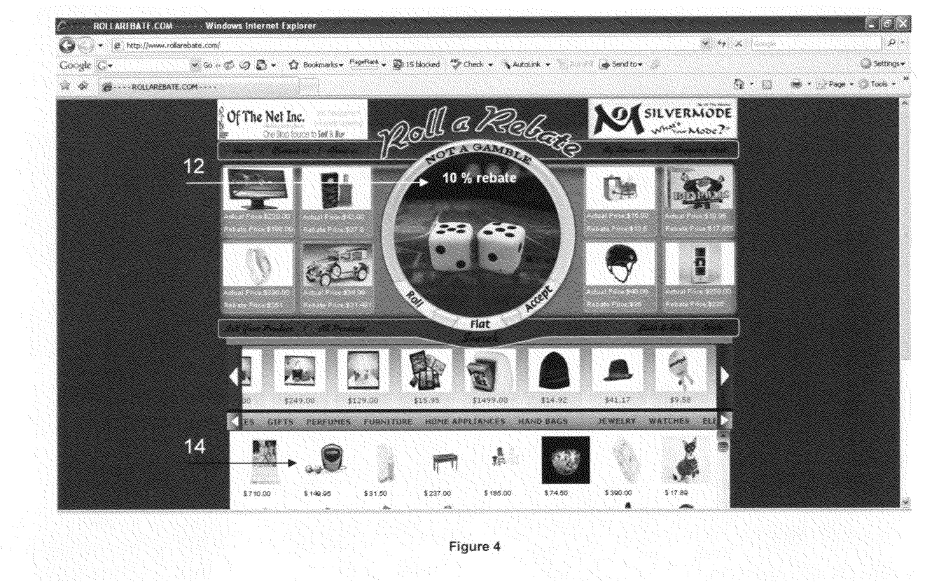

The implementation of the game module may be carried out in different forms. Any games of chance, games of skill, or combinations thereof may be employed in a graphical user interface, within a website, which provides an entertaining gaming experience. As shown in FIGS. 3 and 4, in certain preferred embodiments of the invention, the game may be manifested in a graphical user interface in the form of a conventional gambling-type game. For example, the game module may be implemented as rolling dice 8. In such embodiments, when the server receives the instruction to launch a game module, the server may employ a random number-generating algorithm to produce an awarded discount value 10,12. Alternatively, the server may be programmed with a list of awarded discount values, whereby each time the game module is launched, the returned awarded discount 10,12 is selected from the list in a sequential (or randomized) manner, whereby each subsequent value in the list is randomly predefined. The list of awarded discount values may have upper and lower limits on the awarded discounts, such as between 1% and 99%, or 1% and 50%, or 2% and 25%, or 2% and 12%, and so on. In certain embodiments, the awarded discount will match the outcome of the game. For example, if the game is implemented in the form of a pair of rolling dice, the awarded discount will match the sum total of the values that are returned by the rolled dice (See, e.g., FIGS. 3 and 4). By matching the awarded discount with the outcome of a game, the customer is provided with a more authentic and real-world gaming experience. Of course, this will evoke a sense of excitement in the customer, thereby increasing the amount of time that such customer spends within the website. In addition, the list of awarded discount values that are retrieved from the database may consist of hundreds, or even thousands, of different values, such that a customer could not easily ascertain the sequence of values by continuously launching the game module.

The invention further provides that the customer may be allowed to launch the game module multiple times, such that each time the game module is launched the customer has a chance of being awarded a different discount. In FIG. 3, for example, when the customer launched the game module 4, the awarded discount 10 was 6%. If the customer wanted to play again and launch the game module a second time, the customer may do so. In FIG. 4, for example, the second launch of the game module produced an awarded discount 12 of 10%.

Once the customer is satisfied with the amount of the awarded discount that is produced by the execution of a game module, the customer may, optionally, redeem the awarded discount by purchasing a product offered for sale in the showcase 2. In certain embodiments of the invention, the customer may lock-in the awarded discount. In other words, the customer may instruct the server that the customer wishes to redeem the awarded discount. The server may be provided with such instruction by the customer using a customer-executable command that is accessible within the user platform (website). For example, referring to FIG. 1, the customer may select, or “click,” the “Accept” icon (which is positioned close to the game module icon 4). By selecting the “Accept” icon, an instruction is sent to the server indicating that the awarded discount value 10,12 resulting from the previous game module execution has been selected by the customer for redemption.

Once the customer locks-in, or “Accepts,” an awarded discount, the customer may apply, or redeem, the awarded discount towards the purchase of a product exhibited in the showcase 2. In certain embodiments of the invention, the awarded discount may be applied to all of the products that are offered for sale within the showcase 2. In other embodiments of the invention, the awarded discount may be applied only to a select number or group of products that are offered for sale within the showcase 2.

In still other alternative embodiments of the present invention, the customer may be provided with the opportunity to launch a game module after selecting a product that he/she wishes to purchase. In such embodiments, the awarded discount that is produced by executing the game module may be applied to those products that the customer has already indicated that he/she wishes to purchase. In yet further alternative embodiments, the customer may elect to “save” the awarded discount, such that the customer may apply the awarded discount towards the purchase of a product at some point in the future—perhaps even days later during a subsequent visit to the on-line environment (website).

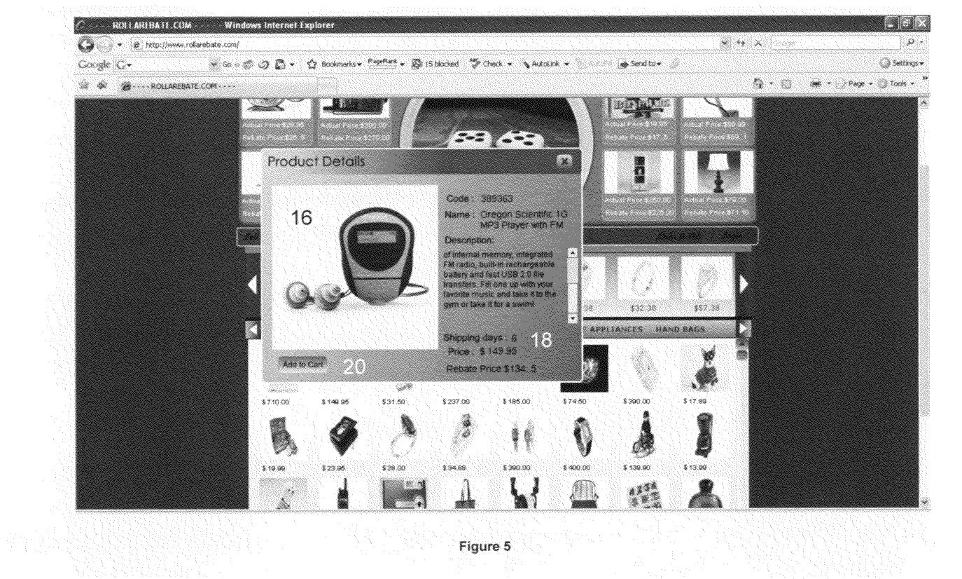

In certain preferred embodiments of the invention, once the customer locks-in the awarded discount, the discount may be redeemed and applied towards the purchase of a product. Referring to FIG. 4, for example, the customer may select a product that he/she wishes to purchase 14. Referring to FIGS. 4 and 5, when the product 14 is selected, additional information may be shown in another graphical user interface 16. The user interface will preferably show the initial selling price, along with the actual selling price 18 as reduced by the awarded discount. The user interface may further include a means 20 for executing a final purchase of the product at the discounted price. Referring to FIG. 5, for example, a customer may select the “Add to Cart” icon 20, whereupon an instruction is provided to the server that the customer wishes to purchase the product at the discounted price.

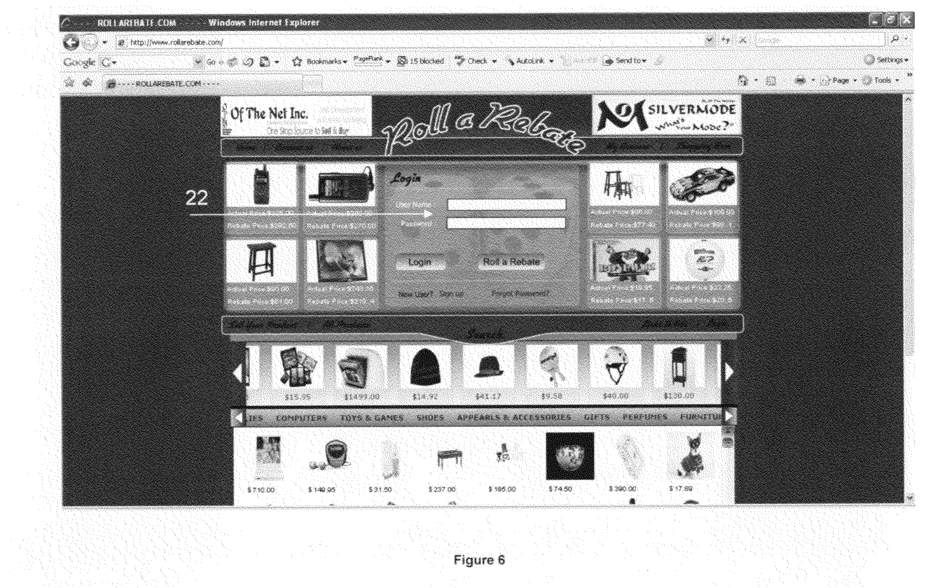

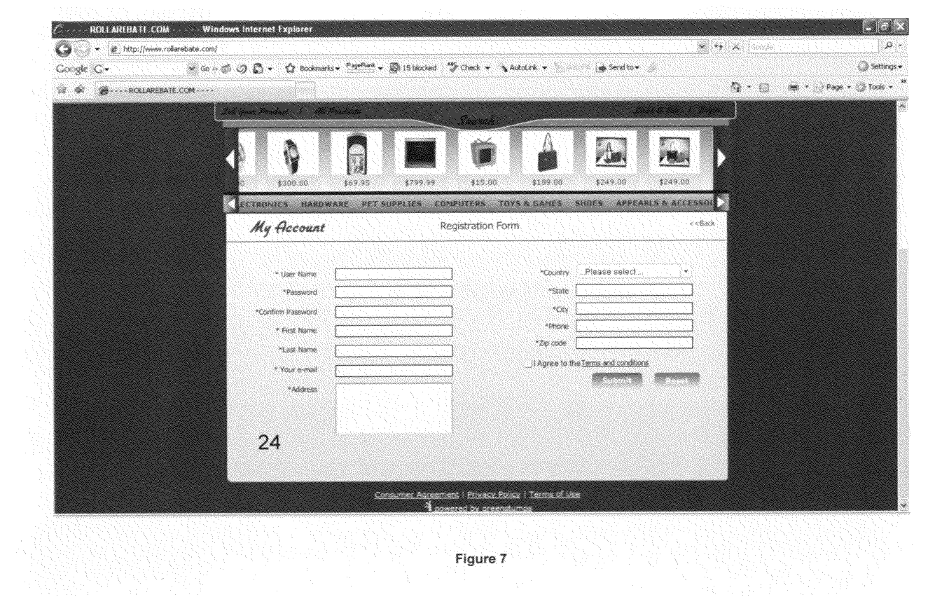

When the server is instructed that a customer wishes to purchase a product, the server will preferably launch additional scripts that are necessary to process the transaction. Such scripts are well-known to those of ordinary skill in the art, which include procedures and scripts for gathering customer shipping information and credit or debit card payment information. In certain preferred embodiments of the invention, portions of such information may be stored, and retrieved within, the server. For example, referring to FIG. 6, prior to a customer purchasing a product, the customer may be prompted to enter a “username” and “password” 22 that is correlated in a table, stored within the database, to such customer's shipping address, e-mail address, and other personal information. The data fields of such table relating to each customer may be populated using an on-line registration form 24 (FIG. 7), in which the customer may enter and submit such information to the server.

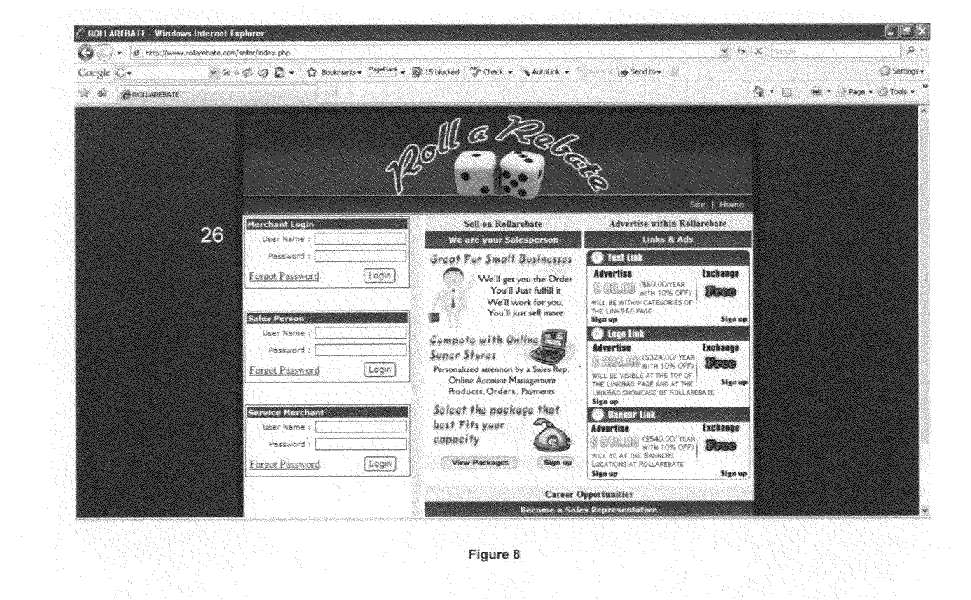

According to the methods of the present invention, each product is offered for sale by a third party merchant. Each merchant may access and provide certain information to the server regarding each of the products that such merchant wishes to sell within the showcase 2. Referring to FIG. 8, similar to the customers that shop within the website described herein, each merchant may access its account by entering and providing the server with an authenticating “username” and “password” 26. Once the merchant successfully enters such authenticating information, which the merchant previously provided the server during a registration process (similar to that described above relative to third party customers), the merchant is provided the ability to specify various types of information relating to the product that it wishes to sell.

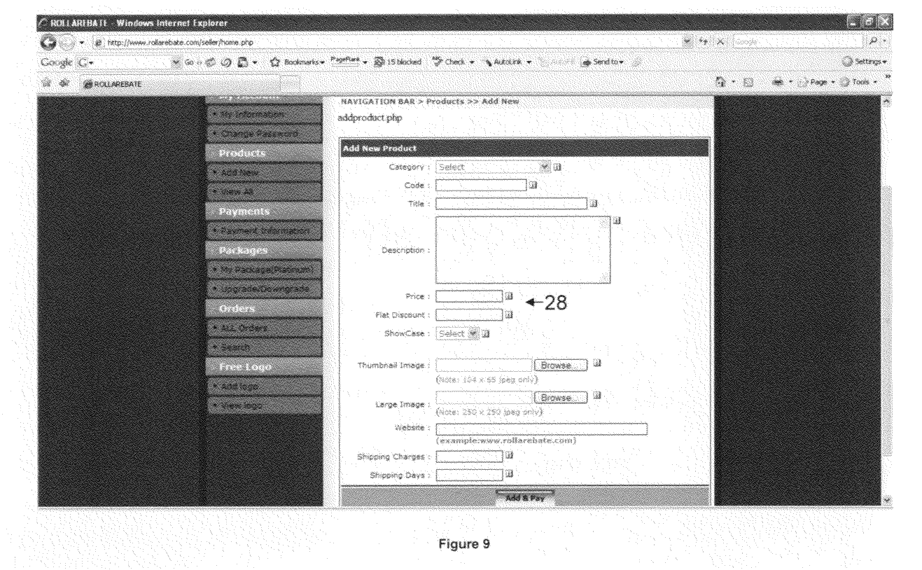

Referring to FIG. 9, for example, the merchant may specify the title and category of goods under which its product will be offered for sale in the showcase 2, a description of the product, the shipping costs for the product, the type of showcase in which the product will be exhibited, and other relevant information. The invention provides that the showcase 2 may include different levels or types of showcases having varying degrees of information, whether such information may include text, images, videos, or combinations thereof. The invention provides that the merchant may be charged a listing fee, which enables the merchant to offer its product for sale within the showcase. Still further, the amount of such listing fee may vary depending on whether the merchant is allowed to include an image or video in its listing, how prominent the listing will be in the showcase 2, and other factors.

Referring again to FIG. 9, the merchant may further provide and upload to the server an image (or video) file pertaining to the product. Importantly, the merchant will be able to specify and provide the server with the initial selling price and maximum awarded discount 28 for each product (shown in FIG. 9 as the “flat discount”). Thus, the initial selling price and maximum discount are provided to a server that hosts, or is capable of communicating with a server that hosts, the game module, such that the merchant's product will not be sold to a customer at a price that is less than the initial selling price reduced by the maximum awarded discount (or “flat discount” amount).

Conversely, in certain embodiments of the invention, the awarded discount that each customer is provided by playing a game will always be less than or equal to the maximum discount that each merchant assigns to its product(s), which such customer may subsequently purchase. This limitation may be implemented in various ways. For example, when the awarded discount is produced by the game module, the server may query a database of products that a plurality of merchants have offered for sale. The server may then cause to be displayed to the customer within the website only those products having a maximum discount value that is equal to or greater than the awarded discount. In such embodiments of the invention, products that are displayed and offered for sale to the customer will not include products having a maximum discount that is assigned by the merchant that is less than the awarded discount. In certain alternative embodiments, all of the products that are shown in or accessible through the showcase 2 may be purchased by the customer, provided that only those products having a maximum awarded discount value that is equal to or greater than the awarded discount may be purchased at a reduced price (whereas all other products may only be purchased at the full initial selling price). The invention further provides that the awarded discount may be implemented in various ways, such as in the form of a dollar amount by which the initial selling price of a product will be reduced or percentage reduction of the initial selling price.

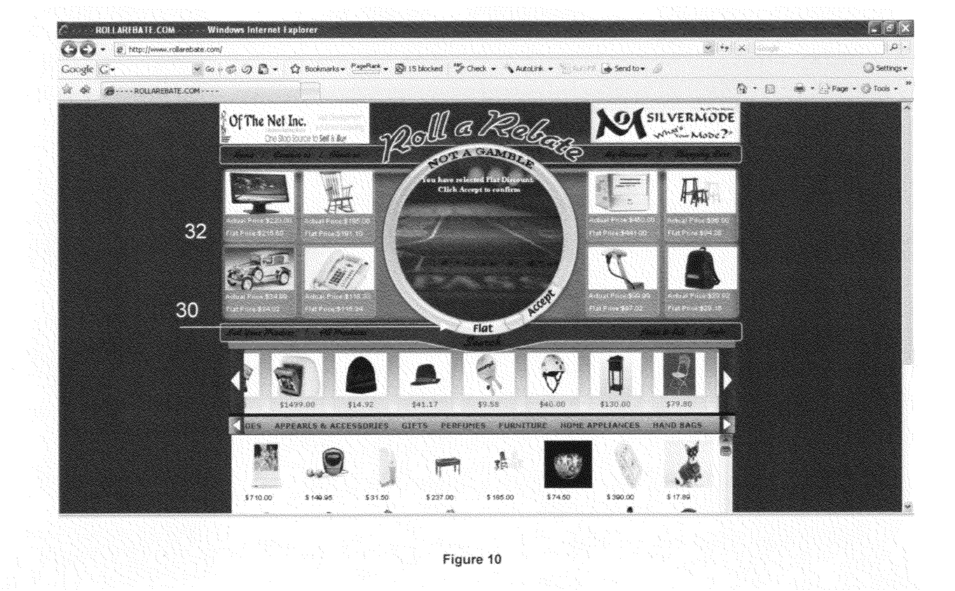

In another embodiment of the invention, a merchant will be able to specify and provide the server with the initial selling price and a “suggested” awarded discount value for each product (shown in FIG. 9, for example, as the “flat discount” 28). In such embodiments, the awarded discount that is provided to a customer that launches the game module may be more or less than the “suggested” awarded discount value. In other words, the awarded discount value is produced independently of the “suggested” awarded discount value. Preferably, however, the awarded discount value that may be awarded by the game module will be limited to a defined upper amount, such as no more than 12%. Preferably, the capped value is communicated to each merchant, such that merchants will understand that the actual applied discount will be no more than the capped value, thereby encouraging the merchant to list and offer its goods for sale in the showcase 2. The “suggested” awarded discount may, optionally, be used in various ways. For example, the “suggested” awarded discount may be awarded upon the customer opting to be awarded a flat-rate discount as discussed further below and shown in FIG. 10.

According to another embodiment of the invention, all of the products shown in the showcase 2 will have a maximum discount value (as specified by the merchant) that is the same as the awarded discount. Referring to FIG. 3, for example, launching the game module from the server produced an awarded discount value 10 of 6%. Accordingly, in certain embodiments, only those products having a maximum discount value (as specified by the merchant) that is equal to 6% will be shown in the showcase 2. Alternatively, in this example, the showcase 2 may exhibit only those products having a maximum discount value that is equal to or less than 6%. Of course, in these embodiments of the invention, the maximum or “suggested” discount value may be applied towards the purchase of a product within the showcase 2. When the showcase 2 exhibits only those products having a maximum discount value that is equal to or less than awarded discount, it should be apparent that the maximum, or “suggested,” discount value 28 assigned by the merchant will directly influence the amount of times that its products are exhibited in the showcase 2. For example, in such embodiments, a product having a maximum, or “suggested,” discount value 28 of 2% will be shown more often than a product having a discount value 28 of 10%, insofar as 2% will more often be equal to or less than the awarded discount than 10% will be).

In additional embodiments of the present invention, the products shown in the showcase 2 may be offered for sale at a price that reflects a flat-rate discount. Referring to FIG. 10, for example, the graphical user interface that presents the showcase 2 may further include a customer-executable command 30 that applies a flat-rate discount to all of the products shown therein. In such embodiments, when a customer executes such command, e.g., by selecting “Flat-Rate” 30, the server is instructed to reduce the initial selling price of all the products exhibited in the showcase 2 by a certain amount. The amount of such reduction may vary among products or it may be consistently applied. The amount of such reduction will preferably be equal to or less than the maximum awarded discount that is assigned to each product. When the “Flat-Rate” 30 instruction is submitted, the invention provides that the reduced selling price is preferably made apparent to the customer. For example, such reduced selling priced may be shown next to an image and/or description of each product 32. By providing the customer with the opportunity to forego playing simulated games in order to realize an awarded discount, the invention provides that even those less patient prospective customers will be more inclined to visit and spend a greater amount of time shopping within such website.

The invention further provides that the “Flat-Rate” discount may represent an amount that each merchant suggests as the appropriate discount for its products. Alternatively, the server may be configured and programmed to only apply, and make accessible to the customer, the “Flat-Rate” discount for products that the customer has previously indicated an intent to buy, such as by adding such products to his/her “shopping cart.” Still further, the server may be configured and programmed to only apply, and make accessible to the customer, the “Flat-Rate” discount for those products that a prospective customer has selected and indicated an intent to potentially purchase, such as in the form of adding such products to a so-called “wish list.” In both cases—that of a “shopping cart” and “wish list”—a customer may select within the on-line environment those products that he/she will or will potentially purchase. When such products are “selected,” the server is provided within an instruction that correlates the identity of the customer with the specific products that he/she has selected. Such correlation may be temporary, permanent, or last until the subject product is finally sold to the customer (or to another third party customer).

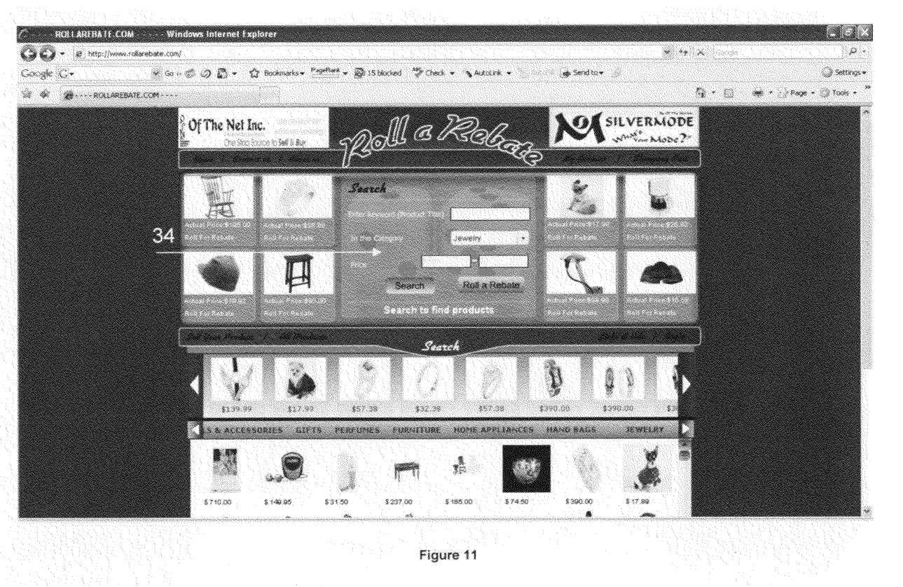

The invention provides that the user terminal, e.g., website, may further include a mechanism that allows the contents of the showcase to be queried. Referring to FIG. 11, for example, a prospective customer may be prompted to enter and submit certain search criteria 34 to the server, wherein the server uses such information to query a table or group of tables contained therein for all products satisfying one or more of such criteria. Preferably, upon locating such table entries that correlate to the customer's search criteria, the server returns and presents in the graphical user interface a listing of all product entries that match, or at least partly match, the customer's search criteria. Referring to FIG. 11, non-limiting examples of search criteria may include keywords (which may pertain to words used in product descriptions that are authored by the respective merchants), categories of products (wherein such categories are specified and programmed into the server when a merchant registers a product with the system as shown in FIG. 9), and/or price ranges of products (which also may have been previously provided to and programmed into the server by the respective merchant).

According to additional preferred embodiments of the present invention, methods are provided for increasing the amount of time that a customer spends reviewing and shopping within an on-line environment. Similar to the other methods described above, such embodiments of the present invention generally comprise (a) providing a customer with a user platform within a terminal, e.g., providing a customer with a website accessible through a networked computer, (b) receiving an instruction from the customer to launch a game module and transmitting the instruction to a server, (c) launching the game module from the server, wherein the game module is operated by the customer using the terminal, wherein operation of the game module unexceptionally results in and provides the customer with an awarded discount, and (d) offering the customer an option to purchase a product for a price that is reduced by the awarded discount. Preferably, the customer is provided the opportunity to select a product to purchase from a plurality of options. According to such embodiments of the invention, the customer is able to launch the game module without paying any fees, such that the customer will be motivated to play a game and, as a result, spend more time within the website and shopping for products therein.

The invention further provides that the showcase 2 may exhibit and be populated with third party advertisements. The inclusion of such advertisements may operate to further attract customers to the website, thereby increasing the amount of time that such individuals visit and shop within such on-line environments. That is, in addition to serving as an on-line source of goods, the showcase may further include advertisements and hyperlinks to third party vendors that provide services that customers may routinely seek. Thus, the on-line environment is preferably a source that is known by customers to offer both goods and services that they may require.

Importantly, the methods and systems described herein have been observed to significantly enhance a customer's on-line viewing and shopping experience. Such enhancements have been found to significantly increase the amount of time that individuals spend visiting, and shopping within, commerce-oriented on-line environments.

For example, in comparison to other on-line gaming features, the ability to launch a game module—which produces an awarded discount that may be redeemed towards the purchase of a product—without (a) paying any fees, (b) making any type of initial deposit using a credit or debit card, whether such deposit is refundable or not, or (c) being obligated to purchase a product to realize the awarded discount, has been shown to significantly increase the amount of time that customers spend within an on-line environment that incorporates such methods of the invention. This increase in the amount of time that customers spend within a website has been shown to significantly increase the amount of time that customers spend shopping for products and, moreover, to significantly increase the likelihood that a customer will make a purchase.

In addition to the significantly increased amount of time that customers will spend within a website that employs the methods of the present invention, the invention has the further advantage of attracting individuals to such website—regardless of whether such customers wish to buy a product. In other words, many individuals will enjoy the risk-free, cost-free, and exciting gaming experience that the present invention provides within a website. In fact, many individuals have been shown to enjoy playing on-line games of chance (or skill)—regardless of whether a discount of any kind is awarded. Thus, by employing the methods described herein in a website, a significantly increased number of people will be attracted to and will visit the website.

Such attraction, and increased web traffic, also translates into significant benefits for the operator of such website. For example, the value of on-line advertising is often influenced and/or proportional to the amount of traffic of the on-line advertiser's website. In other words, the more traffic that a website experiences, the more so-called consumer impressions that ads shown therein will experience. It follows that if a website experiences more traffic as a result of employing the methods of the present invention, the operator of such website will be able to charge higher fees for the right to advertise in the website.

In still further embodiments of the present invention, the methods described herein may be utilized in a plurality of different websites, wherein each such website may be owned and managed by a different entity. In one embodiment, for example, participating third party websites may establish a connection with one or more servers that house one or more game modules. The third party websites will offer products for an initial selling price and, furthermore, will provide customers with the ability to launch a game module, as described herein, in order to pursue an awarded discount. In such embodiments, the game module is launched, provides awarded discounts, and exhibits the other features described above. In such embodiments, however, the awarded discounts may be applied towards the purchase of a product offered for sale in the third party website. In other words, the invention contemplates that the game module (and methods of use thereof) described herein may be located in a centralized server, and connected to, licensed to, and/or integrated into a plurality of participating third party websites.

Similarly, the invention provides that customers may establish a registration with a centralized server that houses the game module, e.g., using an on-line form such as that shown in FIG. 7, which entitles the customer to launch the game modules that are accessible within any of such third party websites. In such embodiments, registered customers may be provided with personalized and customized “shopping carts,” which may be used in participating third party websites.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.
What is claimed is:

1. A method for providing a product, which comprises:
(a) providing a customer with a user platform within a terminal;
(b) receiving an instruction from the customer to launch a game module and transmitting said instruction to a server;
(c) launching the game module from the server, wherein the game module is operated by the customer using the terminal, wherein operation of the game module unexceptionally results in and provides the customer with an awarded discount; and
(d) offering the customer an option to purchase a product for a price that is reduced by the awarded discount, wherein the customer is provided the opportunity to select a product that the customer elects to purchase from a plurality of different products.

2. The method of claim 1, wherein the terminal is a computer and the user platform is a website.

3. The method of claim 2, wherein the server and terminal are connected and communicate through the internet.

4. The method of claim 3, wherein the customer is able to launch the game module without paying any fees.

5. The method of claim 4, wherein the game module is implemented in a graphical user interface within the terminal in the form of rolling dice.

6. The method of claim 4, wherein the customer is provided the option to launch the game module multiple times, wherein each time the game module is launched the awarded discount varies.

7. The method of claim 6, wherein each product is offered for sale by a merchant, wherein the merchant specifies an initial selling price and a maximum discount at which each product may be sold, wherein said initial selling price and maximum discount are provided to the server.

8. The method of claim 7, wherein the awarded discount for each product is less than or equal to the maximum discount.

9. The method of claim 8, wherein the plurality of different products offered for sale to the customer will not include products having a maximum discount that is assigned by the merchant that is less than the awarded discount.

10. A method for providing a product, which comprises:
(a) providing a customer with a website within a computer;
(b) receiving an instruction from the customer to launch a game module and transmitting said instruction to a server via the internet, wherein:
(i) said instruction is made by the customer without paying any fees;
(ii) said game module is implemented in a graphical user interface within the website in the form of rolling dice; and
(iii) the customer is provided the option to launch the game module multiple times;
(c) launching the game module from the server, wherein the game module is operated by the customer using the website, wherein:
(i) operation of the game module unexceptionally results in and provides the customer with an awarded discount; and
(ii) each time the game module is launched the awarded discount varies; and
(d) offering the customer an option to purchase a product for a price that is reduced by the awarded discount, wherein:
(i) the customer is provided the opportunity to select the product that the customer elects to purchase from a plurality of different products;
(ii) each product is offered for sale by a merchant, wherein the merchant specifies an initial selling price and a maximum discount at which each product may be sold;
(iii) the awarded discount for each product is less than or equal to the maximum discount set by the merchant; and
(iv) the plurality of different products offered for sale to the customer will not include products having a maximum discount that is set by the merchant that is less than the awarded discount.

11. A method for increasing the amount of time that a customer spends visiting a website, which comprises:
(a) providing a customer with a website within a terminal;
(b) receiving an instruction from the customer to launch a game module and transmitting said instruction to a server;
(c) launching the game module, from the server, wherein the game module is operated by the customer using the terminal, wherein operation of the game module unexceptionally results in and provides the customer with an awarded discount; and
(d) offering the customer an option to purchase a product for a price that is reduced by the awarded discount, wherein the customer is provided the opportunity to select a product that the customer elects to purchase from a plurality of different products.

12. The method of claim 11, wherein the terminal is a computer.

13. The method of claim 12, wherein the server and terminal are connected and communicate through the internet.

14. The method of claim 13, wherein the customer is able to launch the game module without paying any fees.

15. The method of claim 14, wherein the game module is implemented in a graphical user interface within the terminal in the form of rolling dice.

16. The method of claim 14, wherein the customer is provided the option to launch the game module multiple times, wherein each time the game module is launched the awarded discount varies.

17. The method of claim 16, wherein each product is offered for sale by a merchant, wherein the merchant specifies an initial selling price and a maximum discount at which each product may be sold, wherein said initial selling price and maximum discount are provided to the server.

18. The method of claim 17, wherein the awarded discount for each product is less than or equal to the maximum discount.

19. The method of claim 18, wherein the plurality of different products offered for sale to the customer will not include products having a maximum discount that is set by the merchant that is less than the awarded discount.

20. The method of claim 19, wherein the awarded discount is in the form of a dollar amount or percentage reduction of the initial selling price.
